(19) United States
(12) Patent Application Publication
(10) Pub. No.: US 2004/0231161 A1
(43) Pub. Date: Nov. 25, 2004

(54) Wet shaving device with wire-wrapped blade sets

(75) Inventors: David C. Coffin, Hamden, CT (US); Andrew J. Pennella, Stamford, CT (US); Michael J. Sasuta, Milford, CT (US)

Correspondence Address: Richard R. Michaud, McCormick, Paulding & Huber LLP, CityPlace II, 185 Asylum Street, Hartford, CT, 06103, US

(73) Assignee: Eveready Battery Company, Inc., Westlake, OH

(21) Appl. No.: 10/804,336

(22) Filed: Mar. 19, 2004

Related U.S. Application Data
(60) Provisional application No. 60/457,554, filed on Mar. 26, 2003.

(51) Int. Cl. B26B 21/00

(52) U.S. Cl. 30/50; 30/78

(57) ABSTRACT

A blade cartridge for a wet shaving device comprises a housing defining a cavity in which at least two blade assemblies are disposed. Each blade assembly includes a plurality of blades defining respective cutting edges that are substantially parallel to each other and generally face the cutting edges of another blade assembly. The blades are mounted on a carrier, and a wire is spirally wound about the cutting edges of the blades along the length of the cutting edges.

### CROSS-REFERENCE TO RELATED APPLICATIONS

This application is entitled to the benefit of and incorporates by reference essential subject matter disclosed in Provisional Patent Application No. 60/457,554 filed on Mar. 26, 2003 and U.S. patent application Ser. No. 10/686,992 filed on Oct. 16, 2003.

### FIELD OF THE INVENTION

This invention relates generally to razor blade devices, and more particularly to wire-wrapped blade sets for use in wet shaving razors.

### BACKGROUND OF THE INVENTION

Typical wet shaving devices comprise single or multiple blades aligned in one direction such that the shaving devices are unidirectional (i.e., razor is configured such that the blades can only cut along one direction). A drawback with unidirectional shaving devices is that the razor must be lifted off of a hirsute surface during a return stroke in order to properly position the razor for a subsequent cutting stroke. The return stroke increases the time required for shaving large hirsute surfaces such as, for example, the legs of a user. A second drawback is that the scraping of the skin during the initialization of each cutting stroke can tend to cause discomfort.

In response to the foregoing, it is an object of the present invention to improve upon or overcome the drawbacks and disadvantages of prior art unidirectional wet shaving devices.

### SUMMARY OF THE INVENTION

In a first aspect of the present invention, a blade assembly for use in a wet shaving device comprises a blade carrier. At least two razor blades are mounted on the carrier, each razor blade defining a longitudinal cutting edge. A wire extends over the cutting edges of the razor blades.

In a second aspect of the present invention, a blade cartridge for a wet shaving device comprises a housing including a lower housing member and an upper housing member cooperating to define a cavity. At least two blade assemblies are disposed within the cavity, and each blade assembly includes at least two razor blades mounted on a blade carrier. Each razor blade defines a longitudinal cutting edge, wherein the respective cuffing edges of the razor blades on each blade assembly are substantially parallel to one another. A wire extends generally transversally across the cutting edges of the razor blades on each blade assembly.

Preferably, two blade assemblies are disposed within the cavity of the housing and the cuffing edges of the blades of the first blade assembly generally face toward the cutting edges of the blades of the second blade assembly. This configuration allows for the razor cartridge to cut hair when drawn over a user's skin in either of two generally opposite directions. However, the present invention is not limited in this regard as the cuffing edges of the razor blades of the first razor blade assembly can face away from the cutting edges of the razor blades of the second blade assembly without departing from the broader aspect of the present invention.

An advantage provided by the present invention is increased safety for the user of the wet shaving device. During a shaving operation, the skin is stretched to improve shaving closeness. As a safety measure, the wire wound about the cutting edges of the blades prevents the stretched skin from extruding between the blades. The wire is preferably a fine wire made of metal with a diameter of less than 0.1 mm, and does not interfere with the efficiency and operation of the cutting edges of the blades.

Another advantage of the present invention lies in the bidirectional shaving capabilities of a shaving device with two blade assemblies having blades facing toward or away from each other. As so designed, the shaving device can be used in two opposed directions, and further, the shaving device can be used without removing and reapplying the razor to the skin between strokes. The overall efficiency of the shaving process is improved. The wire of the present invention works especially well during bidirectional shaving because the skin is stretched and contorted in both directions during a shaving operation, and the wire prevents the skin from intruding between the blade of a blade assembly even when the user changes the direction of the shaving stroke.

### BRIEF DESCRIPTION OF THE DRAWINGS

FIG. 1 is a top perspective view of a blade cartridge incorporating two blade assemblies of the present invention.

FIG. 2 is a top perspective view of a blade assembly of the present invention.

FIG. 3 is a bottom perspective view of a blade assembly of the present invention.

FIG. 4 is a cross-sectional view of the blade cartridge of FIG. 1 taken along the line 4-4 in FIG. 1.

### DETAILED DESCRIPTION OF THE PREFERRED EMBODIMENTS

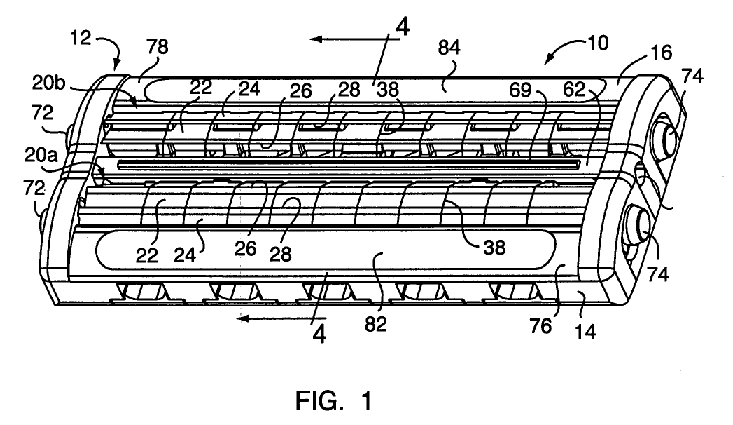

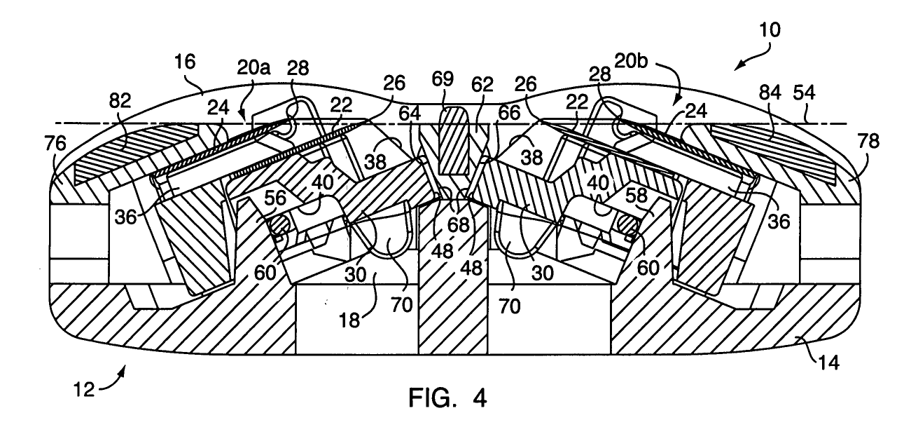

With reference to FIG. 1, a blade cartridge embodying the present invention is designated generally by reference numeral 10. The blade cartridge 10 comprises a housing 12 preferably including a lower housing member 14 and an upper housing member 16 cooperating to define a cavity 18 (see FIG. 4). The upper housing member 16 is generally rectangular, but may be other shapes, such as oval or round, without departing from the scope of the present invention. A first blade assembly 20a and a second blade assembly 20b are disposed within the cavity 18. The first and second blade assemblies 20a and 20b are generally the same shape, and preferably identical to each other.

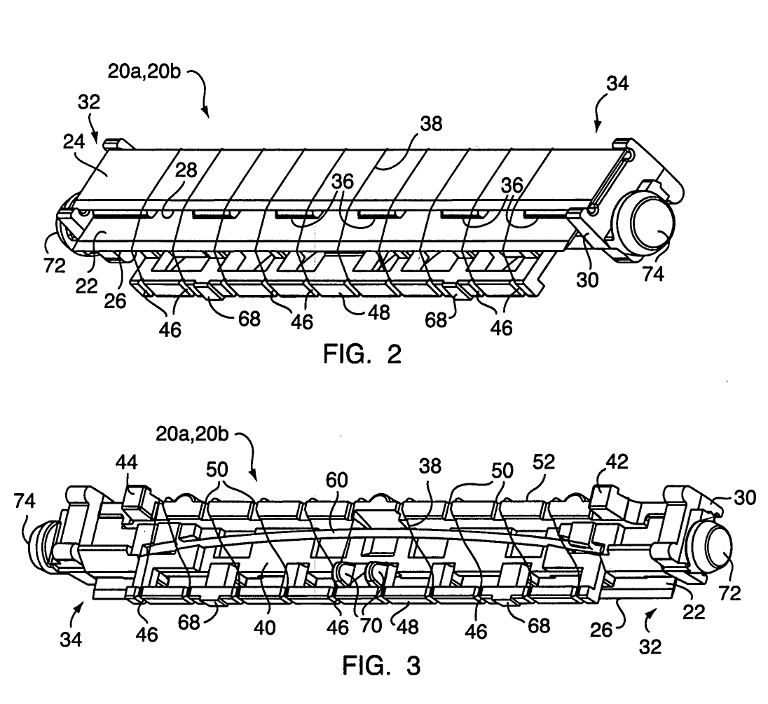

As best shown in FIGS. 2 and 3, each of the blade assemblies 20a and 20b includes a first blade 22 and a second blade 24 having respective cutting edges 26 and 28 that are substantially parallel to each other mounted on a carrier 30. Each of the cutting edges 26 and 28 preferably have a longitudinal dimension extending from a first longitudinal end 32 to a second longitudinal end 34 of the carrier 30. While blade assemblies 20a and 20b are shown as having two blades, it should be generally understood that the blade assemblies can have any practical number of blades, such as, for example, one, two, three, four or five, without departing from the scope of the present invention.

For each blade assembly 20a and 20b, the blades 22, 24 are separated from one another by one or a plurality of spacers 36 interposed between and spaced longitudinally of the blades 22, 24. The spacers 36 may be separate components or may be integral elements of the carrier 30. As shown in FIG. 2, the first blade 22 is located underneath and slightly forward of the second blade 24, whereby the first blade precedes the second blade along a shaving stroke.

Preferably, a wire 38 is spirally wound along the cutting edges 26, 28 of each of the blade assemblies 20a, 20b, and is generally continuously wound from the first longitudinal end 32 to the second longitudinal end 34. The wire 38 provides an additional safety feature for preventing the user from cutting or otherwise damaging the portion of the skin engaging the blades. Preferably, the safety wire protects the user from nicks, cuts and uncomfortable razor burn without interfering with the efficiency of the blades 22, 24, even when the shaving direction changes without removing the shaving device from the user's skin.

A bottom surface 40 of the carrier 30 for each of the blade assemblies 20a and 20b includes first and second posts 42 and 44 respectively located adjacent to the first and second longitudinal ends 32 and 34. Preferably, respective ends of the wire 38 are secured to the first and second posts 42 and 44, and the wire is continuously wound around the blades 22, 24 between the posts.

To increase the effectiveness of the wire 38 in protecting the user's skin without significantly diminishing the effectiveness of the blades 22, 24, the wire 38 should be essentially normal to the blades 22, 24 at the point where the wire 38 crosses the respective cutting edges 26, 28. As specifically seen in FIG. 2, the wire 38 generally should pass across the top surface of the top blade 24 along a generally normal direction to the second cutting edge 28. Such alignment of the wire 38 across the cutting surfaces 26, 28 creates a grill-like effect longitudinally along the blades 22, 24 to reduce the areas between the blades where skin may intrude.

Lateral movement or slipping of the wire 38 during a shaving operation is prevented by grooves or slits provided in the carrier 30. For example, as seen in FIG. 2, a plurality of front slits 46 is provided on front, lower edge 48 of the carrier 30. The slits 46 follow the contour of the carrier 30 to the underside thereof, as shown in FIG. 3. Similar rear slits 50 are provided along the rear, lower edge 52 of the carrier 30. The slits 46 and 50 also act to keep the wire 38 taut by reducing the risk of the wire 38 slipping. To effect the spiral winding of wire 38, the rear slits 50 are preferably offset from the front slits 46. The wire 38 is accordingly angularly displaced along the underside of the carrier 30 yet maintained in the normal direction to the cutting edges 26, 28 as the wire crosses the blades 22, 24.

The wire 38 is preferably made of metal and has a diameter of less than 0.1 mm. A metal wire has a relatively low coefficient of friction with sin so that the necessary shaving resistance is reduced to a minimum. Alternatively, the wire 38 may be made of other materials, such as glass fiber thread or a synthetic material such as nylon. Ideally the material of the wire 38 prevents injury to the user while reducing the necessary shaving resistance and the frictional force that occurs during a shaving operation.

As best shown in FIG. 4, the first and second blade assemblies 20a, 20b are mounted within the cavity 18 defined by the housing 12 of the blade cartridge 10 such that the cutting edges 26, 28 of the first blade assembly 20a generally face cutting edges 26, 28 of the second blade assembly 20b to thereby permit bi-directional shaving (i.e., shaving in both forward and return stroke directions). Planar surfaces of the first and second blade assemblies 20a, 20b are slightly inclined with respect to a shaving plane 54 or plane of contact with the skin of a user. The cutting edges 26, 28 of the blades in a relaxed position extend slightly beyond the shaving plane 54 just enough to expose the edges in order to cut hair from the user's skin without cutting or otherwise damaging the skin. The wire 38 generally runs parallel to the shaving plane 54, and accordingly has a minimal effect on the performance of the cutting edges 26, 28.

The lower housing member 14 defines first and second rearward stop surfaces or fin members 56, 58 against which resilient members 60 of respective first and second blade assemblies 20a, 20b bear. As the blade assemblies 20a and 20b are moved inwardly into the housing 12 under excessive shaving forces, the resilient members 60 deform or flex when pressed against stop surfaces 56 and 58. The deformed resilient members 60 build up restoring forces that return the blade assemblies 20a and 20b to the relaxed position with respect to the shaving plane 54 when the excessive shaving forces are removed. Typically, bidirectional shaving allows the user to shave in forward and return strokes while maintaining contact between the shaving device and the skin. Thus, the need to remove and reapply the shaving device between strokes is eliminated, thus further improving safety.

The upper housing member 16 includes an upper centrally located guard or stop member 62 having first and second forward stop surfaces 64, 66 for respectively engaging front abutment surfaces 68 of the first and second blade assemblies 20a, 20b. The engagement between the stop surfaces 64, 66 and the front abutment surfaces 68 properly locate the cutting edges 26, 28 in the relaxed position with respect to the shaving plane 54. During bidirectional shaving, the resiliency of the blade assemblies 20a, 20b permits one blade assembly (e.g., 20a) to be on a cutting stroke while the other blade assembly (e.g., 20b) is relaxed, and vice versa. Additionally, the resiliency further increases the capacity of the blade assemblies 20a, 20b to follow contours in the skin.

The guard 62 may also include an elastomeric member 69 projecting upwardly therefrom into the shaving plane 54 to aid skin stretching and improve shaving closeness. The wire 38 provided on each blade assembly 20a, 20b prevents any stretched skin from intruding between the blades 22, 24, especially during bi-directional shaving, where the stroke direction can be changed without removing the shaving device from the skin. Alternatively, the guard 62 may include a channel (not shown) filled with a shaving lubricant such as a liquid or gel shaving aid to be applied to the skin surface being shaved.

As shown in FIG. 3, the carrier 30 of each of the blade assemblies 20a, 20b has a bottom surface 40 upon which the resilient members 60 are mounted. Preferably, each resilient member 60 is an elongated strip of flexible material such as, for example, plastic or metal, that is mounted on the bottom surface 40 such that the resilient member 60 is bowed or flexed generally rearwardly from the bottom surface 40. The wire 38 may be routed around projections 70 provided in the center of the carrier 30 so as to avoid interference with the resilient member 60. The center of the bowed or flexed resilient member 60 extends the furthest distance from the carrier 30. Thus, the path of the wire across the underside of the carrier 30, even at an angle, may interfere with the resilient member 60. Accordingly, the rerouted wire 38, around projections 70, gives the resilient member 60 greater clearance to flex.

The carrier 30 of each blade assembly 20a and 20b may further include first and second projections 72, 74 extending outwardly from respective first and second longitudinal ends 32, 34 thereof. The projections 72, 74 allow the user to push downwardly thereon in order to test the safety feature of downward movement of the blade assemblies 20a, 20b within the housing 12 of the blade cartridge 10.

As further shown in FIG. 4, the upper housing member 16 may include first and second caps 76 and 78 for generally covering first and second blade assemblies 20a and 20b, respectively. The upper housing member 16 may also include first and second shaving aids 82 and 84 positioned generally above the first and second caps 76 and 78, respectively, for applying a shaving lubricant such as a liquid or gel shaving aid to the skin surface being shaved. The configuration of the shaving aids 82 and 84, their place of application to the blade cartridge 10, the manner of attachment and/or other means and methods of incorporation may vary widely as known to fit particular requirements. In the alternative, a shaving aid or a shaving aid dispenser may be provided in the center of the housing 12 between the blade assemblies 20a and 20b, and may replace or be in addition to the elastomeric member 68.

The foregoing description of embodiments of the present invention has been presented for the purpose of illustration and description, and is not intended to be exhaustive or to limit the present invention to the form disclosed. As will be recognized by those skilled in the pertinent art to which the present invention pertains, numerous changes and modifications may be made to the above-described embodiments without departing from the broader aspects of the present invention.

What is claimed is:

1. A blade cartridge for a wet shaving devise comprising:
a housing defining a cavity;
first and second razor blade assemblies disposed within said cavity, each blade assembly comprising;
a blade carrier;
at least two razor blades mounted on the carrier, each of said blades defining a longitudinal cutting edge;
a wire extending generally transversely across the cutting edges of said at least two razor blades to prevent excessive extrusion of a user's skin between successive razor blades; and wherein
said cutting edges of the razor blades of the first and second blade assemblies are configured to allow the razor cartridge to cut hair when drawn over a user's skin in either of two different directions.

2. A blade cartridge as defined by claim 1 wherein said cutting edges of said razor blades carried by said first razor blade assembly generally face toward said cuffing edges of said razor blades carried by said second razor blade assembly.

3. A blade cartridge as defined by claim 1 wherein said cutting edges of said razor blades carried by said first razor blade assembly generally face away from said cutting edges of said razor blades carried by said second razor blade assembly.

4. A blade cartridge as defined by claim 1 wherein the number of razor blades carried by the first blade assembly is the same as the number of razor blades carried by the second blade assembly.

5. A blade cartridge as defined by claim 1 wherein the number of razor blades carried by the first blade assembly is different from the number of razor blades carried by the second blade assembly.

6. A blade cartridge as defined by claim 1 wherein the first and second blade assemblies are independently moveable relative to the housing.

7. A blade cartridge as defined by claim 6 further comprising biasing means for urging each of said first and second blade assemblies toward a neutral position in response to forces exerted against said blade assemblies during a shaving operation.
